(19) United States
(12) Patent Application Publication
(10) Pub. No.: US 2026/0048755 A1
(43) Pub. Date: Feb. 19, 2026

(54) METHOD FOR OPERATING A VEHICLE AND VEHICLE

(71) Applicant: Volkswagen Aktiengesellschaft, Wolfsburg (DE)

(72) Inventors: Antony Bonura, Wolfsburg (DE); Volker Wallek, Wolfsburg (DE); Oliver Busse, Wolfsburg (DE); Stefan Klie, Wolfsburg (DE)

(21) Appl. No.: 19/292,495

(22) Filed: Aug. 6, 2025

(30) Foreign Application Priority Data
Aug. 19, 2024 (DE) 102024207868.9

(51) Int. Cl. B60W 50/08; B60W 30/18; B60W 30/182

(52) U.S. Cl. CPC B60W 50/082; B60W 30/18063; B60W 30/182; B60W 2520/06; B60W 2540/215

(57) ABSTRACT

Technologies and techniques for operating a vehicle includes managing transitions between driving modes for opposite driving directions. The vehicle includes a first group of driving modes for moving in a first main driving direction and a second group of driving modes for moving in a second main driving direction, opposite the first. The method involves detecting a first driving mode from the first group as the current mode, detecting a change instruction to switch to a mode for the second main driving direction, and switching to a second driving mode from the second group, distinct from the first mode. The second driving mode is selected based on the first driving mode, enabling coordinated vehicle behavior across directions. The method enhances driver convenience by reducing required actions during maneuvering.

### RELATED APPLICATIONS

The present application claims priority to German Patent App. No. 102024207868.9, filed Aug. 19, 2024, the contents of which are incorporated by reference in their entirety herein.

### TECHNICAL FIELD

The present disclosure relates to a method for operating a vehicle, a vehicle configured to operate according to such a method, a computer program product, a computer-readable medium, and a tangibly-embodied data carrier signal.

### BACKGROUND

In the operation of vehicles, there is a general objective to enhance driver comfort. One approach to achieving this objective involves reducing the number of actions a driver must perform to access specific vehicle functionalities.

Modern vehicles are often equipped with multiple driving modes for forward motion. For example, a distinction may be made between a D driving mode and a B driving mode. The D driving mode enables forward movement of the vehicle at a predetermined creep speed when the driver is not actuating a vehicle pedal. In contrast, the B driving mode decelerates the vehicle to a standstill, such as through an engine brake or recuperator, when the driver is not actuating a vehicle pedal. When switching from a forward driving mode to a reverse driving mode, the differing behaviors of these modes may necessitate one or more pedal adjustments during a maneuvering process.

Examples of methods for operating vehicles are described in U.S. Pat. Nos. 5,593,365 A and 10,253,871 B2.

### SUMMARY

Some aspects of the present disclosure are directed to addressing at least one of the challenges described above. Specifically, some aspects of the present disclosure provide technologies and techniques for operating a vehicle, a vehicle, a computer program product, a computer-readable medium, and a data carrier signal, which reduce the actions required by a user, particularly a driver, during a maneuvering process, thereby enhancing vehicle comfort.

These aspects are achieved by the subject matter of the independent claims. Additional aspects are set forth in the dependent claims, the description, and the figures. Features, advantages, and embodiments described for one subject of the independent claims are equally applicable to the subject matter of the other independent claims and any combination thereof, including in combination with one or more dependent claims.

Features and details described in connection with the method of the present disclosure also apply to the vehicle, computer program product, computer-readable medium, and data carrier signal of the present disclosure, and vice versa, such that reference is made, or may be made, to the individual aspects of the present disclosure.

In some embodiments, a method for operating a vehicle is provided. The vehicle includes a first group of driving modes for moving the vehicle in a first main driving direction and a second group of driving modes for moving the vehicle in a second main driving direction, where the first main driving direction is opposite the second main driving direction. The method includes: detecting a first driving mode as the current driving mode, wherein the first driving mode is selected from the first group of driving modes for moving the vehicle in the first main driving direction, such detection performed by a control unit; detecting a change instruction to switch the current driving mode to a driving mode for moving the vehicle in the second main driving direction, such detection performed by an input unit; and switching the current driving mode to a second driving mode, different from the first driving mode, by the control unit, wherein the second driving mode is selected from the second group of driving modes for moving the vehicle in the second main driving direction, and wherein the selection of the second driving mode is based on the first driving mode.

In some embodiments, a vehicle is provided that includes a first group of driving modes for moving the vehicle in a first main driving direction and a second group of driving modes for moving the vehicle in a second main driving direction, where the first main driving direction is opposite the second main driving direction. The vehicle is configured to operate according to the method described above, particularly as set forth in any one of claims 1 to 5. The vehicle provides the same advantages as those described for the method.

In some embodiments, the detection unit includes at least one acoustic unit configured to receive voice commands. A change instruction for switching the current driving mode may be detected as a voice command. Additionally or alternatively, the detection unit may include at least one camera unit configured to detect a gesture from a user, particularly a driver, of the vehicle. A change instruction for switching the current driving mode may be detected as a gesture.

Some aspects of the present disclosure provide a computer program product comprising instructions that, when executed by a processor of a vehicle, enable the vehicle to perform the methods described herein for operating the vehicle, particularly those methods for switching between driving modes in opposing driving directions. The computer program product provides the same functionalities and benefits as those described for the methods and vehicle configurations of the present disclosure.

Some aspects of the present disclosure are further achieved by a computer-readable medium, particularly a memory medium, storing the computer program product described above, particularly as set forth in claim 8. The computer-readable medium provides the same advantages as those described for the method, vehicle, and/or computer program product.

Some aspects of the present disclosure are further achieved by a data carrier signal that transmits the computer program product described above, particularly as set forth in claim 8. The data carrier signal provides the same advantages as those described for the method, vehicle, computer program product, and/or computer-readable medium.

### BRIEF DESCRIPTION OF THE DRAWINGS

Additional advantages, features, and details of the present disclosure are set forth in the following description, which details exemplary embodiments with reference to the accompanying drawings. The features described in the claims and the description may be essential to the present disclosure, either individually or in any combination. In the drawings:

FIG. 1 illustrates a schematic view of a method according to some aspects of the present disclosure; and

FIG. 2 illustrates a schematic view of a vehicle according to some aspects of the present disclosure.

### DETAILED DESCRIPTION

Some aspects of the present disclosure provide a method for operating a vehicle. The vehicle includes a first group of driving modes for moving the vehicle in a first main driving direction and a second group of driving modes for moving the vehicle in a second main driving direction, where the first main driving direction is opposite the second main driving direction.

In some embodiments, the method includes detecting a first driving mode as the current driving mode, which is the mode in which the vehicle is operating at a given time. The first driving mode is selected from the first group of driving modes, configured for moving the vehicle in the first main driving direction.

The method further includes detecting a change instruction to switch the current driving mode to a driving mode for moving the vehicle in the second main driving direction. This detection may be based on a user action or input, such as from a driver of the vehicle.

Upon detecting the change instruction, the method switches the current driving mode to a second driving mode, distinct from the first driving mode. The second driving mode is selected from the second group of driving modes for moving the vehicle in the second main driving direction. The selection of the second driving mode is based on the first driving mode.

The method described herein enables the selection of different driving modes for moving the vehicle in the second main driving direction, such as for reversing the vehicle, corresponding to different driving modes for moving the vehicle in the first main driving direction, such as for forward driving. This selection is performed automatically, allowing the vehicle to use driving modes that are coordinated across opposing driving directions, thereby enhancing driver convenience and vehicle operability.

In some embodiments, the method is implemented as a computer-implemented method. Additionally or alternatively, certain steps of the method may be performed repeatedly, concurrently, or in the sequence described herein.

For example, if the first driving mode moves the vehicle at a creep speed in the absence of pedal actuation by a user, the second driving mode may exhibit the same creep speed behavior when operating in the opposite driving direction. Alternatively, if the first driving mode decelerates the vehicle to a standstill in the absence of pedal actuation, the second driving mode may similarly decelerate the vehicle to a standstill in the opposite driving direction.

In some embodiments, the first main driving direction corresponds to forward movement of the vehicle, and the second main driving direction corresponds to backward movement of the vehicle, or vice versa. The main driving direction is determined solely by the propulsion direction of the vehicle, independent of any steering angle.

In some embodiments, the first group of driving modes and the second group of driving modes each include an equal number of driving modes, with each driving mode from the first group corresponding to a specific driving mode from the second group. This correspondence ensures consistent vehicle behavior across different driving directions and modes.

Specifically, the number of driving modes in the first group matches the number of driving modes in the second group, with each driving mode in one group uniquely associated with a driving mode in the other group, ensuring tailored vehicle behavior for each direction.

In some embodiments, the first and second driving modes exhibit equivalent vehicle behavior in the absence of pedal actuation by a user. This behavior may include moving the vehicle at a specified creep speed or decelerating the vehicle to a standstill. Here, “equivalent” refers to substantially identical longitudinal acceleration or deceleration of the vehicle, though the direction of movement may differ. The absence of pedal actuation refers to no actuation of pedals controlling longitudinal acceleration, such as the gas or brake pedal, noting that a clutch pedal is typically absent in vehicles with these driving modes.

When switching from a first driving mode with creep movement to a second driving mode with creep movement, the vehicle can be maneuvered using only the brake pedal during a maneuvering process, as the vehicle accelerates automatically upon release of the brake pedal, eliminating the need for pedal switches. Similarly, when switching from a first driving mode with deceleration to a standstill to a second driving mode with deceleration to a standstill, the vehicle can be maneuvered using only the gas pedal.

In some embodiments, the first group of driving modes or the second group of driving modes includes a D mode and a B mode, particularly for forward movement. The D mode is configured to move the vehicle at a specified creep speed in the absence of pedal actuation by a user, particularly a driver. In contrast, the B mode is configured to decelerate the vehicle to a standstill in the absence of pedal actuation by a user, particularly a driver.

The vehicle may be configured as a car or passenger vehicle, or alternatively as a truck. The vehicle may be a hybrid electric vehicle or a fully electric vehicle, with the method described herein being particularly advantageous for fully electric vehicles.

In some embodiments, the vehicle includes at least one detection unit configured to detect a change instruction for switching the current driving mode. The detection unit may include at least one operating element for detecting the change instruction.

Additionally, the vehicle may include at least one control unit configured to manage the execution of the method described herein.

The control unit may include data processing components, such as at least one processor, main memory, or non-volatile data memory.

In some embodiments, at least one driving mode from the first group, or all driving modes from the first group, may be selected via the operating element. Additionally or alternatively, a higher-level driving mode representing the second group of driving modes may be selected via the operating element, with the specific driving mode from the second group selected based on the previously selected first driving mode. The operating element may be configured as a switch, push button, or touch-sensitive display.

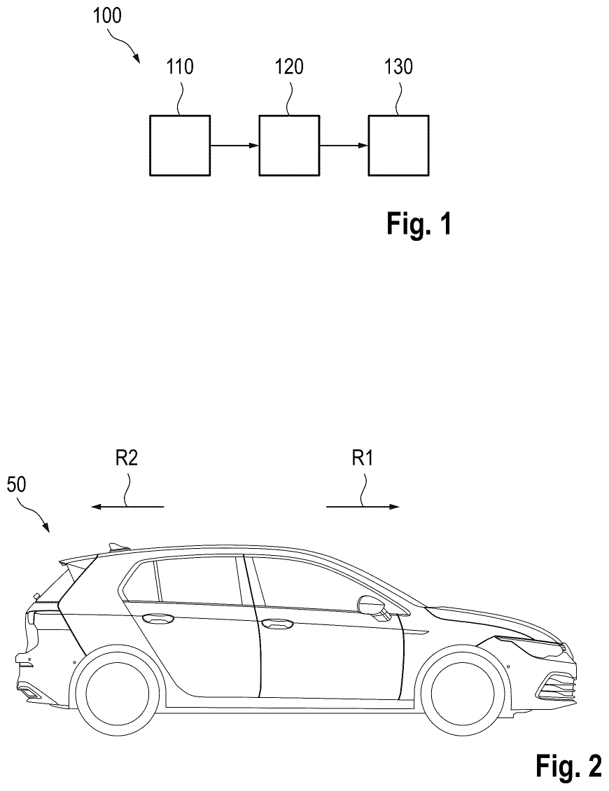

Turning to FIG. 1, the drawing illustrates a schematic view of a method 100 for operating a vehicle 50. The vehicle 50 includes a first group of driving modes for moving the vehicle 50 in a first main driving direction R1 and a second group of driving modes for moving the vehicle 50 in a second main driving direction R2, where the first main driving direction R1 is opposite the second main driving direction R2. The method 100 includes: detecting 110 a first driving mode as the current driving mode, wherein the first driving mode is selected from the first group of driving modes for moving the vehicle 50 in the first main driving direction R1; detecting 120 a change instruction to switch the current driving mode to a driving mode for moving the vehicle 50 in the second main driving direction R2; and switching 130 the current driving mode to a second driving mode, distinct from the first driving mode, wherein the second driving mode is selected from the second group of driving modes for moving the vehicle 50 in the second main driving direction R2, and wherein the selection of the second driving mode is based on the first driving mode, according to some aspects of the present disclosure.

FIG. 2 illustrates a schematic view of a vehicle 50 configured to operate according to the method 100 depicted in FIG. 1. FIG. 2 further depicts the first main driving direction R1 and the second main driving direction R2, where the first main driving direction R1 corresponds to forward movement of the vehicle 50, and the second main driving direction R2 corresponds to backward movement of the vehicle 50, according to some aspects of the present disclosure.

### LIST OF REFERENCE SIGNS

50 vehicle
100 method
110 detecting
120 detecting
130 switching
R1 first main driving direction
R2 second main driving direction

1. A method for operating a vehicle, the vehicle having a first group of driving modes for moving the vehicle in a first main driving direction and a second group of driving modes for moving the vehicle in a second main driving direction opposite the first main driving direction, the method comprising:
detecting, by a control unit, a first driving mode as a current driving mode, wherein the first driving mode is selected from the first group of driving modes for moving the vehicle in the first main driving direction;
detecting, by an input unit, a change instruction to switch the current driving mode to a driving mode for moving the vehicle in the second main driving direction; and
switching, by the control unit, the current driving mode to a second driving mode different from the first driving mode, wherein the second driving mode is selected from the second group of driving modes for moving the vehicle in the second main driving direction, and wherein the second driving mode is selected to maintain consistent vehicle behavior with the first driving mode.

2. The method of claim 1, wherein the first main driving direction corresponds to forward movement of the vehicle, and the second main driving direction corresponds to backward movement of the vehicle.

3. The method of claim 1, wherein the first main driving direction corresponds to backward movement of the vehicle, and the second main driving direction corresponds to forward movement of the vehicle.

4. The method of claim 1, wherein the first group of driving modes and the second group of driving modes each comprise an equal number of driving modes, and each driving mode from the first group is associated with a corresponding driving mode from the second group.

5. The method of claim 1, wherein the first driving mode and the second driving mode exhibit equivalent vehicle behavior in the absence of actuation of a vehicle pedal by a user, the vehicle behavior comprising moving the vehicle at a specified creep speed.

6. The method of claim 1, wherein the first driving mode and the second driving mode exhibit equivalent vehicle behavior in the absence of actuation of a vehicle pedal by a user, the vehicle behavior comprising decelerating the vehicle to a standstill.

7. The method of claim 1, wherein the first group of driving modes comprises a D mode configured to move the vehicle at a specified creep speed in the absence of actuation of a vehicle pedal by a user and a B mode configured to decelerate the vehicle to a standstill in the absence of actuation of a vehicle pedal by a user.

8. A vehicle comprising:
a control unit configured to manage a first group of driving modes for moving the vehicle in a first main driving direction and a second group of driving modes for moving the vehicle in a second main driving direction opposite the first main driving direction;
an input unit configured to detect a change instruction to switch a current driving mode to a driving mode for moving the vehicle in the second main driving direction;
wherein the control unit is further configured to:
detect a first driving mode as the current driving mode, wherein the first driving mode is selected from the first group of driving modes for moving the vehicle in the first main driving direction; and
switch the current driving mode to a second driving mode different from the first driving mode, the second driving mode being selected from the second group of driving modes for moving the vehicle in the second main driving direction, wherein the second driving mode is selected to maintain consistent vehicle behavior with the first driving mode.

9. The vehicle of claim 8, wherein the first main driving direction corresponds to forward movement of the vehicle, and the second main driving direction corresponds to backward movement of the vehicle.

10. The vehicle of claim 8, wherein the first main driving direction corresponds to backward movement of the vehicle, and the second main driving direction corresponds to forward movement of the vehicle.

11. The vehicle of claim 8, wherein the first group of driving modes and the second group of driving modes each comprise an equal number of driving modes, and each driving mode from the first group is associated with a corresponding driving mode from the second group.

12. The vehicle of claim 8, wherein the first driving mode and the second driving mode exhibit equivalent vehicle behavior in the absence of actuation of a vehicle pedal by a user, the vehicle behavior comprising moving the vehicle at a specified creep speed.

13. The vehicle of claim 8, wherein the first driving mode and the second driving mode exhibit equivalent vehicle behavior in the absence of actuation of a vehicle pedal by a user, the vehicle behavior comprising decelerating the vehicle to a standstill.

14. The vehicle of claim 8, wherein the first group of driving modes comprises a D mode configured to move the vehicle at a specified creep speed in the absence of actuation of a vehicle pedal by a user and a B mode configured to decelerate the vehicle to a standstill in the absence of actuation of a vehicle pedal by a user.

15. A computer-readable storage medium storing instructions that, when executed by a processor of a vehicle, cause the vehicle to perform a method comprising:
detecting, by a control unit, a first driving mode as a current driving mode, wherein the first driving mode is selected from a first group of driving modes for moving the vehicle in a first main driving direction;
detecting, by an input unit, a change instruction to switch the current driving mode to a driving mode for moving the vehicle in a second main driving direction opposite the first main driving direction; and
switching, by the control unit, the current driving mode to a second driving mode different from the first driving mode, wherein the second driving mode is selected from a second group of driving modes for moving the vehicle in the second main driving direction, and wherein the second driving mode is selected to maintain consistent vehicle behavior with the first driving mode.

16. The computer-readable storage medium of claim 15, wherein the first main driving direction corresponds to one of forward or backward movement of the vehicle, and the second main driving direction corresponds to the other of forward or backward movement of the vehicle.

17. The computer-readable storage medium of claim 15, wherein the first group of driving modes and the second group of driving modes each comprise an equal number of driving modes, and each driving mode from the first group is associated with a corresponding driving mode from the second group.

18. The computer-readable storage medium of claim 15, wherein the first driving mode and the second driving mode exhibit equivalent vehicle behavior in the absence of actuation of a vehicle pedal by a user, the vehicle behavior comprising moving the vehicle at a specified creep speed.

19. The computer-readable storage medium of claim 15, wherein the first driving mode and the second driving mode exhibit equivalent vehicle behavior in the absence of actuation of a vehicle pedal by a user, the vehicle behavior comprising decelerating the vehicle to a standstill.

20. The computer-readable storage medium of claim 15, wherein the first group of driving modes comprises a D mode configured to move the vehicle at a specified creep speed in the absence of actuation of a vehicle pedal by a user and a B mode configured to decelerate the vehicle to a standstill in the absence of actuation of a vehicle pedal by a user.
